(19) United States
(12) Patent Application Publication
(10) Pub. No.: US 2010/0031324 A1
(43) Pub. Date: Feb. 4, 2010

(54) APPARATUS AND METHOD FOR DYNAMIC LICENSING ACCESS TO WIRELESS NETWORK INFORMATION

(76) Inventors: Ronald F. Strich, Grove City, FL (US); Randy C. Willig, Fort Collins, CO (US)

Correspondence Address: PERKINS COIE LLP;PATENT-SEA, P.O. BOX 1247, SEATTLE, WA, 98111-1247, US

(21) Appl. No.: 12/400,707

(22) Filed: Mar. 9, 2009

Related U.S. Application Data
(60) Provisional application No. 61/034,581, filed on Mar. 7, 2008.
(60) Provisional application No. 61/034,577, filed on Mar. 7, 2008.
(60) Provisional application No. 61/034,644, filed on Mar. 7, 2008.

(51) Int. Cl. G06F 17/30; H04L 29/06

(52) U.S. Cl. 726/4; 726/30

(57) ABSTRACT

An apparatus and method for dynamically licensing access to wireless network information provides multiple third parties with selective access to network device information in real-time. Information is collected in real-time from a plurality of sensing and control devices configured in a network arrangement. Information may be collected from each of the sensing and control devices regardless of the communication protocol associated with the device. The collected information is stored and aggregated by a service broker, which selectively licenses access to the information, or subsets of the information, to one or more third parties.

### CROSS-REFERENCE TO RELATED APPLICATION(S)

This application claims priority to, and incorporate by reference in their entirety, U.S. Provisional Patent Application No. 61/034,581, entitled “Apparatus and Method for Dynamic Licensing Access to Wireless Network Information,” filed on Mar. 7, 2008 (attorney docket no. 69002.8007.US00); U.S. Provisional Patent Application No. 61/034,577, entitled “Apparatus and Method for Transparent Interface to a Wireless Network,” filed on Mar. 7, 2008 (attorney docket no. 69002.8006.US00); and U.S. Provisional Patent Application No. 61/034,644, entitled “Apparatus and Method for Brokered Processing of Sensor Network Data,” filed on Mar. 7, 2008 (attorney docket no. 69002.8011.US00).

### TECHNICAL FIELD

The present technology relates to apparatus and methods for dynamically managing access to selective information and control features associated with a plurality of sensing and control nodes disposed in a network configuration.

### BACKGROUND

Prior methods of accessing and controlling a network of sensing and/or control devices require a tremendous knowledge of particular device characteristics (e.g., manufacturer, interface characteristics, data link protocols, network protocols, radio frequency (RF) characteristics, and the like). As such, application programmers are forced to focus on interface- and device-specific details in addition to providing for required network functions. Consequently, a particular network of sensing and/or control devices, once configured, is very inflexible in terms of function and device interchangeability.

In addition, prior to the advent of mesh wireless networks and associated low-power/low data rate (LP/LDR) wireless sensors and controls, applications developers had to rely upon indirect methods and associated apparatus (e.g., service reports, usage reports, field calls, surveys, etc.) for gathering data about product reliability, usages, supplies consumed, real-time power requirements, etc. In addition, there was no way to exercise remote control of products outside of dedicated local control mechanisms.

Most current commercial applications and academic research topics relating to networks of low-power, wireless sensing and control devices (or networks that include one or more wireless devices) focus on transport efficiency, synchronized transmission/reception times, and optimized routing protocols. Accordingly, specific devices or classes of devices are considered and optimized, but these applications/models do not give adequate consideration to the higher level functions that these networks are required to perform. For example, conventional design techniques do not consider the wide range of sensors or controls of a given type (e.g., humidity sensor, accelerometer, or valve controller); the varied power, processing, or bandwidth models of devices across a network; the differing types of data link and network protocols (e.g., IEEE 802.15.4, ZigBee) that these devices utilized; or the particulars of where and under what conditions these devices might be deployed. The result is that application-specific networks of devices exhibit an extremely inflexible architecture that forces application programmers to focus on device- and/or network-specific considerations rather than overall functions of the system.

With regard to access to information and control features, prior methods are disadvantageous because entities that require access to the data and control features of products, such as utility companies, appliance manufacturers, owners, and supply vendors, are forced to make decisions related to their field of concern based upon old data, estimates, or projections.

In addition, with advent of mesh wireless networks and associated low-power/low data rate (LP/LDR) wireless sensors and controls, the networking community is enjoying significant growth in the areas of distributed sensing and control systems, where a network (e.g., physical, logical, virtual, or a combination thereof) of interrelated sensors may include many different numbers and types of end node devices. Many of these devices sense data that first must be processed by digital signal processing (or other) algorithms in order to determine event occurrences, trend predications, and like circumstances, or to filter the data, or for other reasons. The reasons and applications for processing data samples in order to obtain useful data are numerous and diverse.

In system applications that may require hundreds of sensors, device designers are very focused on controlling the cost of individual sensors. The goal is to design in only those hardware and software elements that are essential to performing a specific function, say, sensing the amount of carbon monoxide in the ambient area, or measuring the turbidity of a water sample passing through a valve. But for the sensor to provide meaningful, near-real-time information, such as a CO₂ or water contamination alarm, the data sampled must be processed on-board. Consequently, device designers are presently forced to provide dedicated circuits and software (typically application-specific integrated circuits) on-device to perform the data processing functions.

With regard to providing on-device capabilities for performing digital signal, or other, forms of processing, current techniques are disadvantageous because additional processing circuits substantially increase the overall cost of a device. In addition, these circuits designed to perform specific processing tasks, and thus cannot be easily altered to perform other processing functions.

### SUMMARY

An apparatus and method for dynamically licensing access to wireless network information provides multiple third parties with selective access to network device information in real-time. Information is collected in real-time from a plurality of sensing and control devices configured in a network arrangement. Information may be collected from each of the sensing and control devices regardless of the communication protocol associated with the device. The collected information is stored and aggregated by a service broker, which selectively licenses access to the information, or subsets of the information, to one or more third parties.

### BRIEF DESCRIPTION OF THE DRAWINGS

FIG. 1 is a block diagram of an existing network of heterogeneous devices.

FIG. 2 is a block diagram of a network including a transparent network interface.

FIG. 3 is a block diagram illustrating configuration of device attributes.

FIG. 4 is a block diagram illustrating local configuration of a network model.

FIG. 5 is a block diagram illustrating remote configuration of a network model.

FIG. 6 is a block diagram of a network with a transparent network interface.

FIG. 7 is a block diagram of a transport datagram payload.

FIG. 8 is a block diagram of a device properties record.

FIG. 9 is a block diagram of a device properties profile of a device properties record.

FIG. 10 is a block diagram of a device deployment profile of a device properties record.

FIG. 11 is a block diagram of a device run-time profile of a device properties record.

FIG. 12 is a block diagram of a dynamic information registration system.

FIG. 13 is a block diagram of a system for dynamic licensing of information and control features.

FIG. 14 is a block diagram of a system for brokered processing of network data.

FIG. 15 is a block diagram of a system for brokered processing of network data.

FIG. 16 is a block diagram of a system for brokered processing of network data.

### DETAILED DESCRIPTION

An apparatus and method for dynamically licensing access to wireless network information provides multiple third parties with selective access to network device information in real-time. Information is collected in real-time from a plurality of sensing and control devices configured in a network arrangement. Information may be collected from each of the sensing and control devices regardless of the communication protocol associated with the device. The collected information is stored and aggregated by a service broker, which selectively licenses access to the information, or subsets of the information, to one or more third parties. In some embodiments, the information is analyzed and/or interpreted prior to being provided to a third party.

The present technology can be used in any system configuration that employs a network of sensing and control devices, and is particularly applicable to network configurations that include one or more low-power, wireless devices. The present technology provides to one or more application programs restricted access to subsets of device properties. The present technology allows application programmers to focus development on the data transmitted/received as opposed to device design parameters, environmental parameters, and network characteristics.

The present technology provides several advantages, including but not limited to: the ability to abstract the properties of a network of sensors and control points to enable optimization heretofore unavailable; the ability to enable programming access to “virtual” sensors without underlying sensor expertise or network composition knowledge; the ability to create logical networks of sensors and controls; the ability to restrict access to device-specific data and controls in a network of devices; the ability to restrict access and control to specific devices in a network; the ability to restrict access to specific licensees (users, manufacturers, etc.); the ability to provide access to data sets to external entities without revealing details about the devices, availability, or other licensees to the data; and the ability for each licensee to access a unique set of data.

### 1. Transparent Interface to a Wireless Network

It is difficult at the time of design and manufacture of disparate devices (i.e., the end node devices and the network of devices itself), or at the time of deployment of the network, or “mesh,” to consolidate information from the disparate devices. For example, consider a solar-powered end node sensor/control device that at the time of deployment is disposed under a tree, thus obstructing its source of power. Consider further that a floating solar-powered device may undergo multiple, similar obstructions during run time, and its availability may vary throughout deployment. If a given device and its characteristics are modeled correctly, as well as modeling other parameters of the network, then such situations as noted can effectively be accommodated at deployment time and dynamically during run time. In the case noted, a modeled system can be optimized according to the present technology when power goes down, and the function of the device, or “processing,” (e.g., wind speed sensing) can effectively be transferred to another device within the mesh having the capability to perform such a function.

Accordingly, a method and apparatus may be provided for transparently configuring and managing network devices, including one or more low-power, wireless devices, which models functionality of these devices. That is, the method and apparatus models what data the devices generate and receive, what functions these devices perform, and what algorithms these devices implement to generate or receive the data. In some embodiments, the present technology comprehends modeling a set of sensing and control points within an end node device (i.e., a communication-enabled transducer that is not necessarily wireless, but may have wireless access). These sensing and control points are modeled in such a way such that a system comprising these points can be optimized by applications executing within the system, without the applications requiring knowledge of specific hardware characteristics (e.g., the specific processor, sensing element, and network interface employed within a given device). The present technology supports applications that are developed based on a model of each of the devices, where characteristics that are not required to support system function are transparent to the applications.

The present technology provides a complete, dynamic, system-wide management and control solution for networks of sensing and control points. It is particularly useful in many present day low-power/low data rate (LP/LDR) networks, where the configuration of devices on the network is dynamic, thus causing the overall functional, power, bandwidth, and other profiles of the network to undergo significant changes due to changes in number and type of devices, deployment parameters, ambient node conditions (e.g., weather, time of day), and other ephemeral constraints (e.g., electromagnetic environment). Thus, there is a need to determine and manage the operating profile of present day LP/LDR networks to an extent that has not been heretofore provided. According to the present technology, application programmers need only deal with functions of the devices on the network.

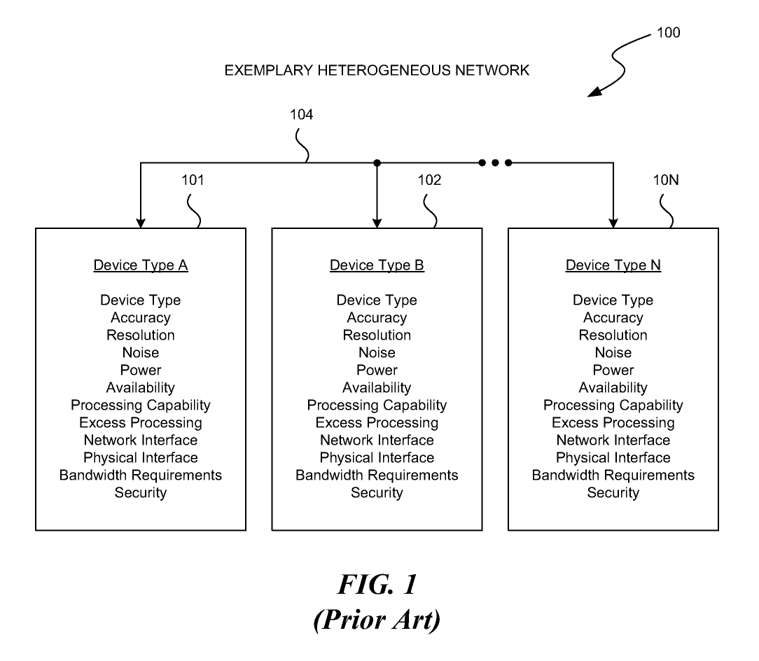

Referring to FIG. 1, a block diagram is presented illustrating an exemplary present day network 100 of heterogeneous devices 101-10N. Although not exhaustive, each of the devices 101-10N exhibits certain listed attributes such as device type (e.g., anemometer, rain gauge, temperature sensor, valve controller), accuracy, resolution, noise, power requirements (e.g., AC mains, battery, solar), processing capability (e.g., MIPS), excess processing capacity (e.g., 90% idle), network interface (e.g., Ethernet, ZigBee, Bluetooth), physical interface (i.e., IEEE 802.15.4, IEEE 802.11, cellular), bandwidth requirements, and security (e.g., cipher code, transmission security). For example, in a meteorological applications area, device A 101 could be embodied as an anemometer, device B 102 as a rain gauge, and device N 10N as a temperature sensor.

Although interconnected through a network medium 104 (e.g., Ethernet, Bluetooth, ZigBee, and the like), each of the devices 101-10N manages function, power, bandwidth, and other listed features in an isolated fashion, that is, in complete isolation to power concerns of other devices 101-10N in the network 100 or of the network medium 104, or of transport mechanisms across the network medium 104. Since each of the devices 101-10N does not maintain any understanding of the power/bandwidth capabilities or restrictions of the other devices 101-10N in the network 100, there is no system-wide usage coordination. Perhaps one of the devices 101-10N may also serve as a system collection/control point, or a separate device (not shown) connected to the network 104 may serve as the system collection/control point. In either case, any present day application program that is provided to perform management of the system 100 will have to consider all of the attributes listed for each of the devices 101-10N. If any of the devices 101-10N breaks or is otherwise replaced, there is no mechanism for porting function or for allowing for substitution of a different type of device. This is because any present day application program that interfaces to these devices 101-10N must perform device-level interface and control functions in addition to those required system-level functions.

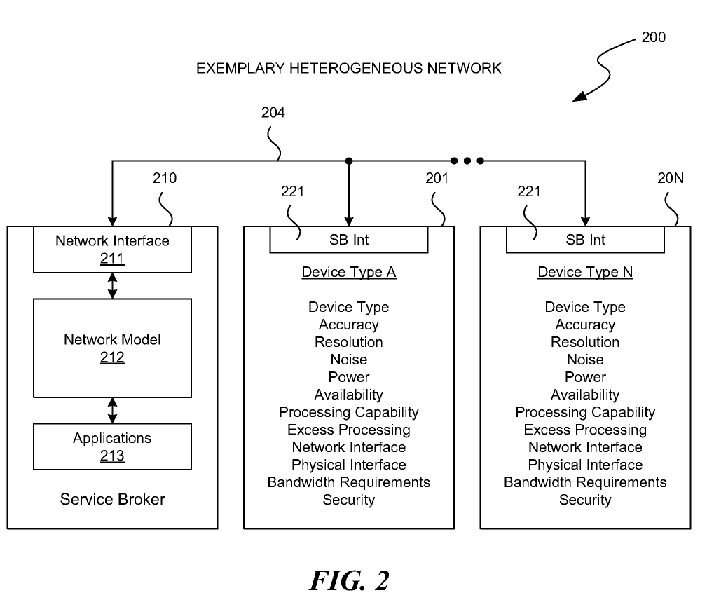

Now referring to FIG. 2, an exemplary heterogeneous network 200 according to the technology is presented that features a service broker 210 that is coupled to one or more end node devices 201-20N that exhibit the same attributes of like numbered devices 101-10N described with reference to FIG. 1. A difference between the devices 101-10N of FIG. 1 and the devices 201-20N according to the present technology is that the devices 201-20N include service broker interface logic 221 that provides for intelligent interface with the service broker 210.

The service broker 210 includes a network interface 211 for interfacing over the network medium 204 to the end nodes 201-20N. Network model logic 212 is coupled to the network interface 211. System applications 213 exercise functions (i.e., sensing data and controlling control points) of the system 200 by reading data from and writing data to the network model logic 212. In some embodiments, the network model logic 212 comprises a dynamic database of network and device parameters. For example, the network model logic may include a database 411 such as that depicted by FIG. 4, described below. The network model logic 212 may also comprise an operating system that provides for execution of each of the applications 213 and that furthermore provides for command and control of the devices 201-20N, where the underlying network- and device-interface characteristics are transparent to the applications 213. As such, in some embodiments, the network model logic 212 is analogous to a present day application programming interface (API) that is employed with, for example, a desktop computer operating system (e.g., Unix).

The present technology quantifies the functions, accuracy, resolution, power, processing, bandwidth, and other properties of each device 201-20N within a network 200 of devices. These attributes are provided within the network model logic 212 and are selectively exposed to applications 213, if at all. For example, it is not required for an application 213 to be provided with a given device's network or physical interface properties. All that an application 213 need note is the device type, its accuracy and resolution, and other characteristics that are essential to perform system functions. Accordingly, apparatus and methods are provided to define the requirements of participation in the network 200 and to additionally define the requirements of associated transport mechanisms. These defined properties are evaluated at the device and network level by the network-aware service broker 210, so that functions, power, processing, bandwidth, and other system characteristics are managed at both the device and system level without degrading the overall performance of the network 200.

Devices 201-20N support a cooperative system-wide function/power/bandwidth management strategy as exploited via development of application programs 213 and through optimization features of the network model logic 212. One exemplary optimization feature contemplates the ability to dynamically tokenize mission critical datagram parameters to enable reduction in bandwidth when required (along with corresponding power required for transmit/receive functions) and to schedule power use coincident with power availability and system mission. Other optimization features that may be provided via the network model logic 212 contemplate attributes and algorithms that are employed to optimize the system 200 operation without requiring that applications 213 have a direct knowledge of device hardware, the transport medium, link speeds, security, redundancy, etc.

In some embodiments, the service broker 210 comprises a Unix-based processor that is coupled to the network medium 204 via the Internet. Accordingly, the network interface 211 comprises an Internet access point and logic required to communicate over the given network medium 204 (e.g., 802.15.4 data link devices).

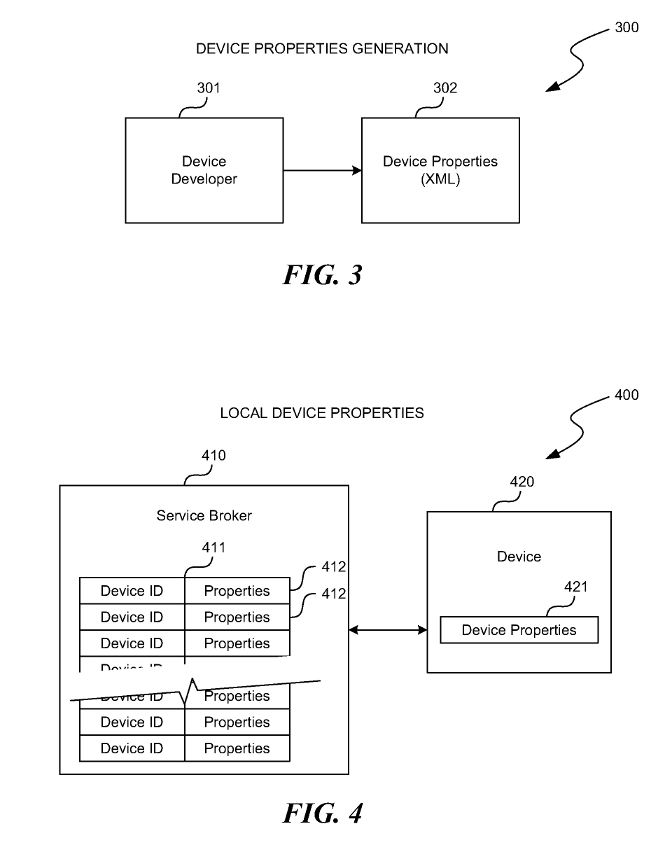

FIG. 3 depicts an embodiment of a method 300 for configuring the aforementioned attributes within the network model logic 212 for each of the devices 201-20N. A device developer 301 configures a device properties data file 302 that describes device properties. In some embodiments, the device properties data file 302 is an XML file, although other file formats may be used. An example XML device properties data file is depicted by Table 1:

TABLE 1

| | |
|---|---|
| 1 | <?xml version=“1.0”?> |
| 2 | <deviceProperties> |
| 3 | <property id=“1” name=“Type” profile=“Device”/> |
| 4 | <property id=“2” name=“Manufacturer” profile=“Device”/> |
| 5 | <property id=“3” name=“Serial Number” profile=“Device”/> |
| 6 | <property id=“4” name=“Power Source” profile=“Device”/> |
| 7 | <property id=“5” name=“Accuracy” profile=“Device”/> |
| 8 | <property id=“6” name=“Resolution” profile=“Device”/> |
| 9 | <property id=“7” name=“Location” profile=“Device Deployment”/> |
| 10 | <property id=“8” name=“Power Source Level” profile=“Device |
| | Runtime”/> |
| 11 | <property id=“9” name=“Temperature” profile=“Device Runtime”/> |
| 12 | </deviceProperties> |

The device properties are contained within the “deviceProperties” and “/deviceProperties” tags of lines 2 and 12, respectively. Each device property is identified by an “id,” “name,” and “profile,” as illustrated by the device properties of lines 3-11. As described in additional detail below, device properties may be associated with different profiles. For example, device properties may be included in profiles based on the time at which the device properties are obtainable. Lines 3-8 illustrate several device properties available at the time of manufacture and included in a “Device” profile—Type, Manufacturer, Serial Number, Power Source, Accuracy, and Resolution. Line 9 illustrates a device property available at the time of deployment and included in a “Device Deployment” profile—Location. Lines 10-11 illustrate device properties available at run-time and included in a “Device Runtime” profile—Power Source Level and Temperature.

The device properties data file 302 may be loaded into the network model logic 212 prior to deployment of the system 200, or it may be obtained from the device 201-20N or remotely at run time.

The device properties 302 describe a corresponding physical device 201-20N in a physical network 204 through a hardware and medium-independent modeling mechanism, thus removing the requirement that application programs 211 be provided with such details. As noted above, the properties 302 allow for control and optimization capabilities of the system 200 and include such attributes as functions, sub-functions, data available, power available, processor MIPS, algorithms used, hops away on the network for interface, hours power available each day, and the criticality and latency of the data. In a manner analogous to a simulation environment, a system 200 according to the present technology provides substantially more optimization points.

In addition to physical device properties, the properties 302 can also embodied as “synthetic,” or “virtual,” properties 302 since the network model 212 according to the present technology can combine multiple types of data within a device to create more valuable properties 302. For example, signal strength between devices 201-20N is often crudely measured by checking the RF signal strength when a data transmission is received. This signal strength (e.g., Link Quality Indication (LQI) or Receive Signal Strength Indication) are only approximations of the RF signal strength. The failing of such a mechanism for measuring signal strength is that it does not account for very weak data transmission (e.g., “packets”) that failed error checking means (e.g., cyclic redundancy checksum (CRC) checks), and thus are never considered as having been received. Accordingly, an initiating device 201-20N might send 10 packets, and the broker 210 might only receive five packets, but those 5 packets would exhibit an LQI of “very strong signal” when, actually, it would have been more precise to note the percentage of packets received, in addition to the LQI, and to thus synthesize a more accurate virtual signal strength property 302 that reflects only 50 percent of the packets were received.

Network model logic 212, including a dynamic database of network and device parameters, may be configured locally or remotely. FIG. 4 shows a diagram 400 of embodiments of the present technology in which a network model 411 is configured though local device access. At run time, a service broker 410 accesses those devices 420 on the network (only one device 420 shown) that include local device properties logic 421. Device attributes are provided via the properties logic 421 over the network to the broker 410 for population of the network model 411. Each device 420 is assigned a unique properties record 412 within the network model 411 and each record 412 includes a unique device ID field that correlates the record 412 with the device 420. A given device 420 having separately addressable sub-elements (not shown) may comprise multiple device properties logic 421 and will be provided with corresponding multiple records 412 in the network model 411. One example of such a device 420 is a temperature and humidity sensor that shares a single communications processor, power supply, and other shared logic within the device enclosure.

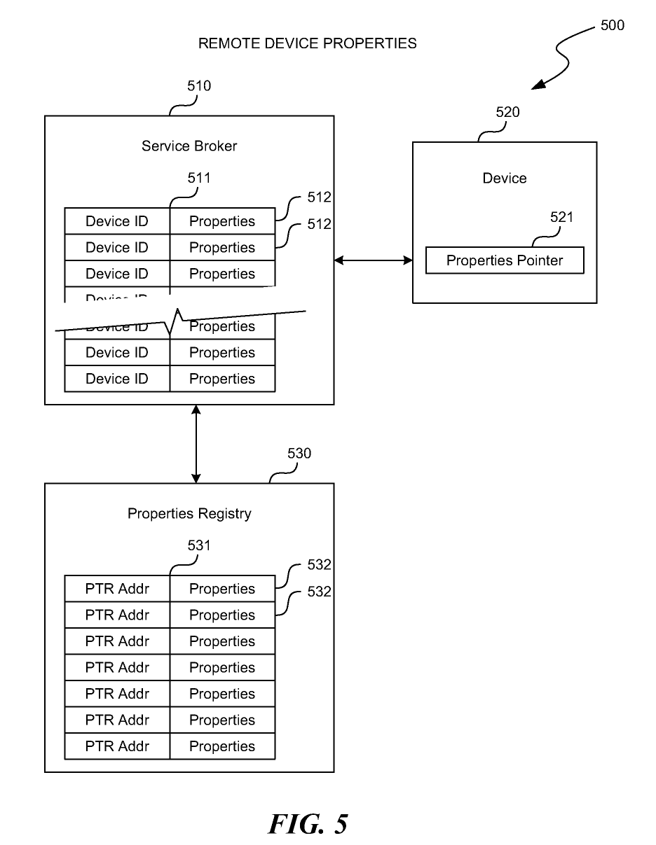

Now turning to FIG. 5, a diagram 500 of embodiments of the present technology are shown in which a network model 511 is configured remotely via use of a properties registry 530. In such embodiments, a service broker 510 accesses those devices 520 on the network (only one device 520 shown) that include properties pointer logic 521. The properties pointer logic 521 provides a pointer address to a particular record 532 in remote properties logic 531 disposed within the properties registry 530. In some embodiments, the properties pointer logic 521 provides a URL to the particular record 532, where the properties logic is disposed within a server couple to the Internet. Alternative embodiments comprehend a properties registry 530 within a service broker according to the present technology, like the broker 210 of FIG. 2. The properties pointer address is thus provided via the properties pointer logic 521 over the network to the broker 510 in order to facilitate population of the network model 511 with properties for the device 520. The broker 510 accesses the properties registry 530 via the same network or a different networking interface by providing the pointer address to the remote properties logic 531 which, in turn, provides the corresponding device properties.

As in the embodiment 400 of FIG. 4, each device 520 is assigned a unique properties record 512 within the model 511 and each record 512 exhibits a unique device ID field that correlates the record 512 with the device 520. Additionally, a given device 520 having separately addressable sub-elements (not shown) may comprise multiple device properties pointer logic 521, multiple remote properties records 532, and will be provided with corresponding multiple records 512 in the network model 511. One skilled in the art will understand that FIG. 5 depicts a technique for indirectly obtaining properties that are associated with a device 520, such as a description of device type, parameters measured, accuracy, and etc. To obtain real-time data from the device itself, an embodiment of FIG. 4 is combined with an embodiment of FIG. 5.

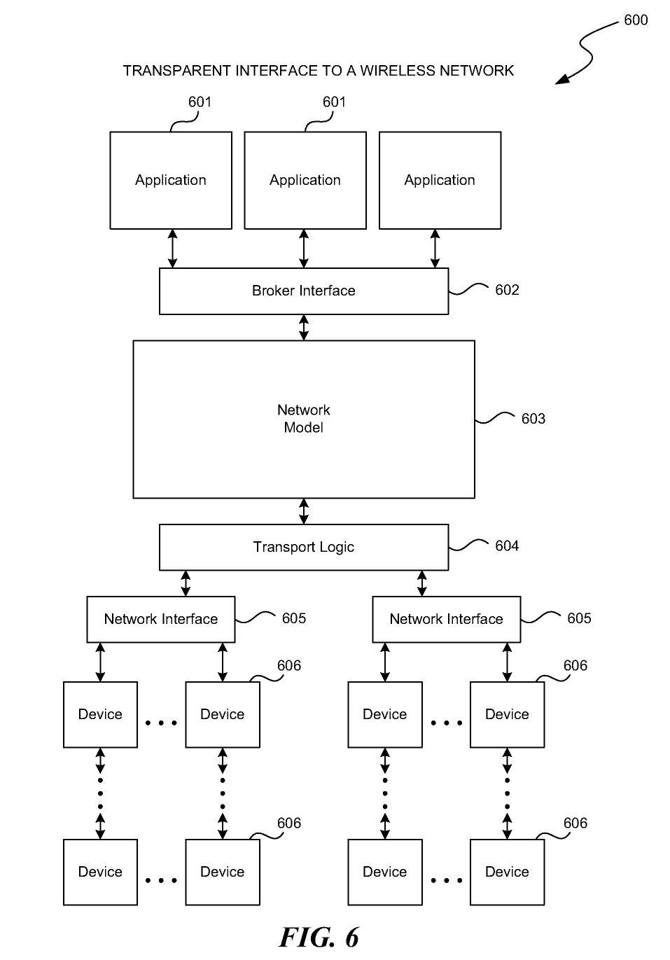

A more detailed diagram of a transparent system 600 according to the present technology is presented in FIG. 6. The system 600 includes one or more applications 601 that are developed to interface to devices 606 according to the present technology by monitoring and manipulating properties, or characteristics, within a network model 603. The applications 601 interface to the network model 603 through broker interface logic 602. The broker interface logic 602 provides a programming interface to the applications that enables control and monitoring of network functions and data without requiring knowledge of specific device characteristics, network characteristics, transport characteristics, and the like. An example broker interface is depicted by Table 2:

TABLE 2

| | |
|---|---|
| 1 | getNetworks( ):Network[ ] |
| 2 | getNetwork(n:NetworkID):Network |
| 3 | findDevices(n:NetworkID):Device[ ] |
| 4 | getDevices(n:NetworkID):Device[ ] |
| 5 | getDevice(n:NetworkID, d:DeviceID):Device |
| 6 | getProperties(n:NetworkID, d:DeviceID):Property[ ] |
| 7 | getProperty(n:NetworkID, d:DeviceID, a:PropertyID):Property |
| 8 | readProperty(n:NetworkID, d:DeviceID, a:PropertyID):PropertyValue |
| 9 | writeProperty(n:NetworkID, d:DeviceID, a:PropertyID, |
| | v:PropertyValue):void |

The functions depicted by lines 1-9 may be used by an application to control and monitor network functions and data. For example, the findDevices( ) function of line 3 may be used to discover the devices on a network and the functions performed by those devices. The application may access information from the network model using functions including getDevice( ), getProperties( ), getProperty( ), etc., as depicted by lines 5-7. In addition, the application may monitor and control device functions using functions including readProperty( ) and writeProperty( ), as depicted by lines 8-9.

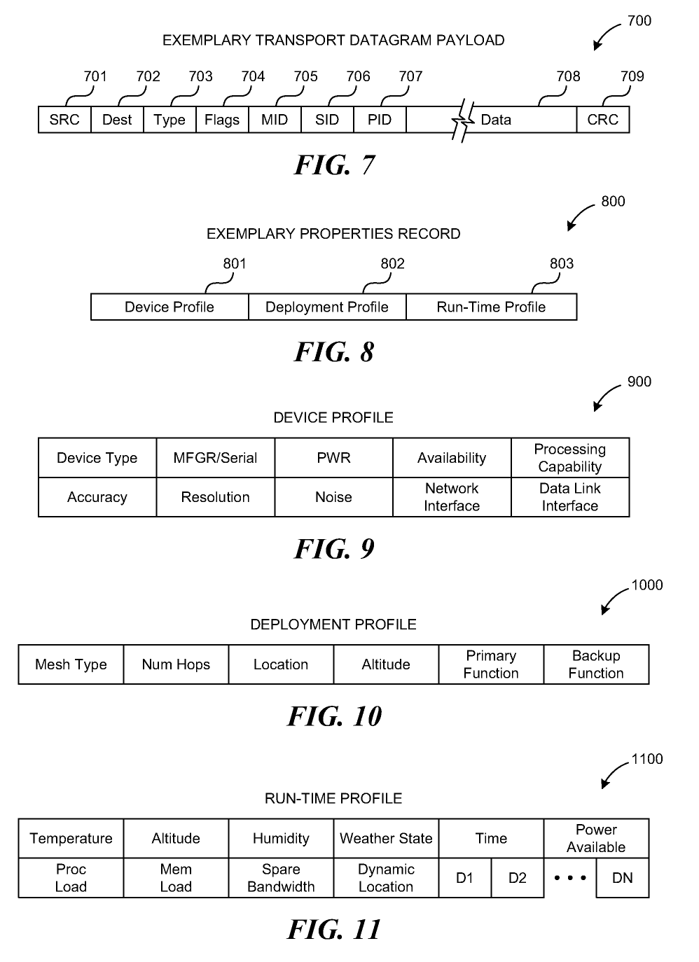

Returning to FIG. 6, the network model 603 communicates with the devices 606 via transport logic 604, which interfaces to individual network interfaces 605 as configured by system design. The transport logic 604 constructs a transport datagram payload that is appropriate for the network interface 605, as described in further detail below in reference to FIG. 7, and delivers the payload to a device via the network interface.

A variety of network interfaces 605 may be used to communicate with devices 606. A network interface 605 may comprise an industry standard (e.g., ZigBee), a proprietary device profile (e.g., General Electric, Whirlpool, etc.), a third party proprietary profile (such as that offered by Tendril Networks, Inc.), or a combination of these and other network interfaces. For example, some embodiments contemplate an IP interface logic 605 and a ZigBee interface logic 605 that utilize TCP as upper layer transport 604. Accordingly, the devices 606 are accessed via Ethernet and 802.15.4 links. Use of an open industry standard, such as ZigBee, promotes interoperability between devices from different manufacturers.

As shown in FIG. 6, the devices 606 may not all be directly interfaced to a network interface 605, but instead may form a mesh or other configuration. Consequently, the transport logic 604 and network interface logic 605 includes those functions required to communicate with and control a given device that may be multiple hops away and each device 606 includes logic to route communications packets.

In summary, each of the applications 601 manipulates parameters in the network model 603 via the broker programming interface 602. The network model 603, in turn, communicates with the devices 606 over the networks to transmit/receive data. The network model 603 also includes those functions, as described above, to optimize functions, communications, bandwidth, power, etc., as required by system specifications, so that the applications need not have any knowledge thereof.

In some embodiments, the applications 601, broker interface 602, network model 603, transport logic 604, and network interface 605 reside within a common service broker according to the present technology as described with reference to FIG. 3. Alternative embodiments contemplate disposal of these broker elements 601-605 in exclusive processors that are coupled together via a network medium (e.g., an 802.11 network) that supports latency requirements of the system 600. Other embodiments dispose selective ones of the broker elements 601-605 within individual devices 606 on the network 600. Still other embodiments comprehend a combination of some or all of the previously noted embodiments.

A service broker collects information from network sensing and control devices through the use of device properties records. A device properties record, or “capabilities string,” describes in detail each device 606 and is employed within the network model 603. The capabilities string is an extensive expression of the device 606 or sub-device 606. The string is extracted or otherwise accessed by a service broker according to the present technology The string details the sensor type, the specific data provided/required, accuracy, noise characteristics, physical location, sensor use, and, but not limited to, run-time characteristics (e.g., cold, cloudy, etc.), and/or other data. Thus, some embodiments of the present technology consider a capabilities string that includes base device design parameters, device deployment parameters (e.g., hops to broker, latitude/longitude), and run-time parameters (e.g., current ephemeral environment). The capabilities string thus becomes part of a data structure, or record, in the service broker. The capabilities string is described in further detail below, in reference to FIGS. 7-11.

Thus, the present technology involves abstraction of a variable or property in a device 606, making it a real-time programmable property in a network model. Accordingly, some embodiments model a network according to the present technology as a distributed cache. As one skilled in the art will appreciate, application programs 601 do not possess knowledge of the cache. They do not maintain its coherency. They do not flush the cache when it is dirty. Application programs 601 simply read and write parameters that are contained within the cache, and the coherency model (i.e., network model 603) takes care of management, consistency, and coherency.

A second aspect of the distributed cache embodiment is that data is tagged with its last update time, thus enabling applications to request data within a specified time window. This time tagging aspect saves network bandwidth by enabling an application to access data stored within the network model 603 as opposed to accessing a device 606 over the network interface 605.

Another aspect of the distributed cache embodiment is that a network model 603 according to the present technology comprehends so-called “volatile” data, that is, data that can be modified on a device 606 without requiring a read or write transaction. Examples of volatile data include, but are not limited to, temperature, voltage, or pressure measurements that can change in a device 606 without requiring a transaction to occur each time the data changes. Any number of schemes can be employed to maintain coherency of the data.

In some embodiments, the network model 603 comprises a plurality of XML records, although other record formats are contemplated. In other embodiments, a service broker comprises a transport-level driver 604 within a layered communications protocol that provides for direct application program access. In some embodiments, the elements 603-605 are disposed as Java applications executing on a Java virtual machine (JVM) coupled to the network medium, for purposes of providing reliable transport of data over a network. The broker interface 602 provides access to upper layer applications 601.

Now referring to FIG. 7, a block diagram is presented featuring an exemplary transport datagram payload 700 according to the present technology. The payload 700 has a source port field 701, a destination port field 702, a transport type field 703, a flags field 704, a message identification field 705, and service identification field 706, property identification field 707, a data field 708, and a cyclic redundancy checksum (CRC) field 709. The source field 701 identifies a transport-level port on a sending device from which the payload 700 originates. The destination field 702 identifies a transport-level port on the receiving device for which the payload 700 is intended. The type field 703 identifies the type of transport employed (e.g., reliable datagram, best effort, etc.). The flags field 704 describes useful information that distinguishes one payload 700 from another payload 700, which includes, but is not limited to, sequence numbers, acknowledge indications, initial transmission indication, and retransmit indication.

The message ID field 705 identifies the type of transport payload 700 such as read request, read response, discovery, etc. The service ID field 706 identifies the type of service provided by the device or broker to which the payload 700 applies. Exemplary services include temperature/humidity services, wind sensing services, fluid turbidity services, etc. The property ID field 707 designates the specific property (e.g., temperature, humidity, wind speed, wind direction, water level, turbidity) of the device corresponding to that contained in the data field 708. The CRC field 709 is a CRC of the payload 700. In some embodiments, the CRC field 709 is an 8-bit CRC.

The transport datagram payload 700 described above is exemplary, and is provided to teach aspects of the present technology. A layered architecture as employed therein enables the optimization of transport, payload fields, compression of fields, etc., in a manner that is transparent to any of the applications 601 that access the network model 603.

The diagram of FIG. 8 depicts an exemplary device properties record 800 that is disposed within a network model according to the present technology. As previously described, a device properties record 800 includes one or more device properties, which are aggregated into, for example, a device properties profile 801, a device deployment profile 802, and a device run-time profile 803. Properties corresponding to each of the profiles 801-803 are selectively exposed to application programs as required for exercise of system functions. Those properties, and each property required by the network model for timely and efficient operation of the system are provided with a property ID 707. Thus, datagrams 700 transmitted over the network uniquely address particular devices, or sub-devices, and properties provided thereby. Data associated with these property IDs is written to/from the network model, and ultimately to the end device, or is accessed by an application program.

FIG. 9 shows an exemplary device profile 900 within a properties record in a network model according to the present technology. The device profile 900 includes, for example, but is not limited to, device type, device manufacturer and serial number, type of device power required, availability of the device (e.g., daylight only), processing capabilities (e.g., throughput and reserve capacity), data accuracy, data resolution, sensor noise characteristics, network interface for communication with the device, and data link interface required.

FIG. 10 shows an exemplary device deployment profile 1000 within a properties record in a network model according to the present technology. The deployment profile 1000 includes, for example, but is not limited to, type of network mesh (e.g., broadcast, star, multi-hop), number of hops from the network interface, device location (e.g., lat/long), altitude, primary device function, and any backup functions that it can perform.

FIG. 11 shows an exemplary device run-time profile 1100 within a properties record in a network model according to the present technology. The run-time profile 1100 includes, for example, but is not limited to, current temperature, altitude, humidity, weather state (e.g. overcast, sunny, smoke), time, remaining power, processing load, memory load, spare bandwidth, location (e.g., lat/long relative to deployment location), and data associated with functional properties.

### 2. Dynamic Licensing Access to Wireless Network Information

The present technology provides for dynamic registration of any apparatus having data and/or control features that are accessible by one or more end node devices, as described herein. In some embodiments, these end node devices utilize LP/LDR wireless mesh networks as a primary means of transferring data. Although wireless mesh networks and related devices are employed as examples herein, the present technology comprehends the use of other networking technologies (e.g., Internet, networks utilizing electrical power lines for communication, proprietary networks) and combinations of these technologies. In addition, the present technology comprehends dynamic licensing (or access control) of data and/or control features of products configured as described herein.

The objects, features, and advantages of the transparent interface to a wireless network, described above, are extensible to registration and licensing applications. Consider a product such as a dishwasher that is disposed within an owner's facility (e.g., a home). Currently, the state-of-the-art provides no mechanism to access data provided by the dishwasher or to control the dishwasher, short of accessing the data and controlling the dishwasher in direct physical proximity thereto. This is because dishwashers (and many other products as well) do not provide data/control interfaces that are remotely accessible. One skilled in the art will appreciate that desktop computers, satellite television receivers, Internet gateways, and a few other devices do allow for remote data access and control, but these devices all must be accessed through dedicated hardware paths (i.e., telephone lines, cable, etc.). In addition, one skilled will appreciate that there are many so called “smart” home controls available, but these much be accessed via dedicated circuits as well.

The cost of configuring dedicated wiring and circuits has heretofore precluded product manufacturers from including remote sensors and controls in their products. They realize that there is no market for products that have these features. But with the advent of low-cost, LP/LDR wireless sensors and controls, opportunities exist for providing products with the aforementioned features, in part because entities other than the consumer may be willing to bear the cost of provision. For example, an electric utility company may be willing to provide product rebates, or even bear the entire cost of, for example, a dishwasher that is enabled with wireless data access and control features to which the company has access. If the utility company can monitor the power consumed by significant numbers of products providing data according to the present technology within, for example, a power sub-grid, the utility could effectively manage peak sub-grid power by selectively turning off products within the sub-grid, thereby obviating any requirement to provide expensive peaker plants and facilities that are seldom used.

The example above illustrates a substantially new data and control economy, by which dynamic access to data provided by and control of products configured with sensor and control devices are enabled.

As aspects of the present technology are discussed below, it is noted that the present technology applies to virtually any product or other device having data and/or control features that are accessible and which can be transmitted via LP/LDR devices or other networks.

Consider the device properties described above with reference to FIGS. 7-11. Any number of entities may be interested in these properties, but only certain entities may be authorized access thereto. An entity may be authorized to access data comprising one or more transactions, data collected during a given time period, data related to one or more particular sensors, and/or other data. For example, Manufacturer A may only be authorized to view data associated with products that Manufacturer A has produced. A utility company may be authorized to access data related to utility consumption (e.g., how many cycles of the dishwasher are employed), but not related to customer profiles (e.g., what brand of dishwasher, what brand of soap is used, how old the appliance is). Alternatively, a retailer may be allowed access to reliability data for a given time window in order to develop effective warranty programs. A supplier of exhaustible components (e.g., soap) may be allowed access to data related only to components usage and levels. And so on. The types and extents of access/control restriction are virtually infinite, and the present technology is provided to enable these functions to be accomplished.

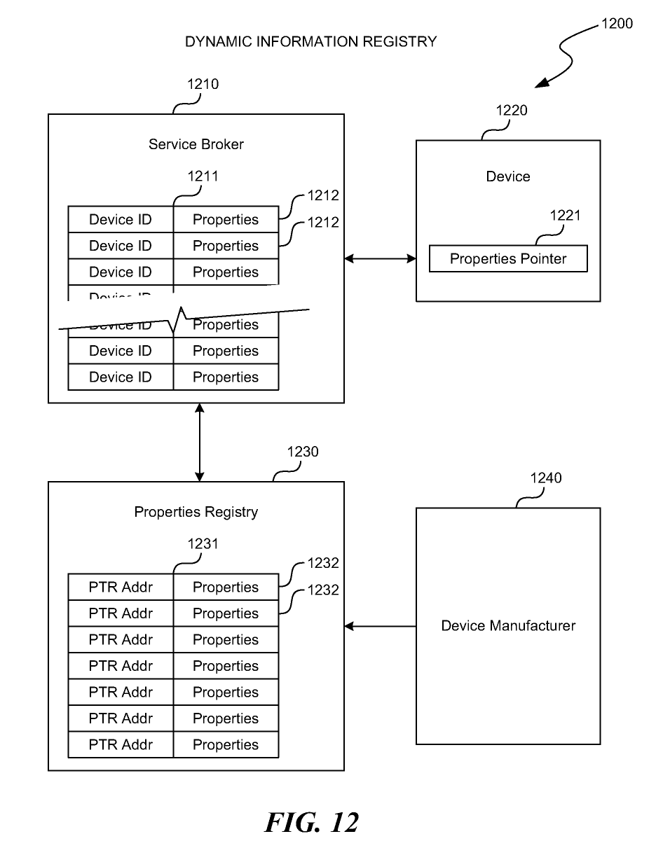

Turning now to FIG. 12, a block diagram is presented of a dynamic information registration system 1200 according to the present technology. Like the system 500 described with reference to FIG. 5, the dynamic registration system 1200 includes a network model 1211 that is configured remotely via use of a properties registry 1230. In this embodiment, a service broker 1210 accesses those devices 1220 on the network (only one device 1220 shown) that comprise properties pointer logic 1221. The properties pointer logic 1221 provides a pointer address to a particular record 1232 in remote properties logic 1231 disposed within the properties registry 1230. In some embodiments, the properties pointer logic 1221 provides a URL to the particular record 1232, where the properties logic is disposed within a server coupled to the Internet. Other embodiments comprehend a properties registry 1230 within a service broker according to the present technology, like the broker 210 of FIG. 2.

The properties pointer address is thus provided via the properties pointer logic 1221 over the network to the broker 1210 for population of the network model 1211. The broker 1210 accesses the properties registry 1230 via the same network or a different networking interface by providing the pointer address to the remote properties logic 1231 which, in turn, provides the corresponding device properties. As in the embodiment 400 of FIG. 4, each device 1220 is assigned a unique properties record 1212 within the model 1211 and each record 1212 exhibits a unique device ID field that correlates the record 1212 with the device 1220. Additionally, a given device 1220 having separately addressable sub-elements (not shown) may comprise multiple device properties pointer logic 1221, multiple remote properties records 1232, and will be provided with corresponding multiple records 1212 in the network model 1211.

In contrast to the system 500 of FIG. 5, the remote properties logic 1231 is populated in part (i.e., a subset of the records 1232) by one or more device manufacturers 1240. For example, when a product is manufactured, it is configured with one or more devices 1200 therein having properties pointer logic 1221. As described above, the properties pointer logic 1221 includes a properties pointer that enables a corresponding properties record 1232 to be accessed from a properties registry 1230. In some embodiments, the properties pointer 1221 comprises a product serial number. In other embodiments, the properties pointer 1221 comprises a unique MAC address (wireless or wired) corresponding to the device 1220.

Prior to shipment, the manufacturer 1240 enters the properties into the properties record 1232 by any number of extant techniques to include population of a remote database accessed over the Internet, etc. The dynamic aspect of registration occurs when the product including the device 1220 is commissioned into service. Some embodiments contemplate commissioning products for dynamic registration via entry of a serial number or key code by an end user (not shown) into the corresponding record 1232, or an input that is otherwise associated with the corresponding record 1232. Accordingly, the service broker 1210 is directed to communicate with the device 1220 to obtain the pointer 1221 and to access the registry 1230 in order to configure its network model 1211. In addition to accessing the record 1232 from the remote registry 1230, the service broker 1210 also is enabled to provide additional properties in its device properties record 1212, such as properties provided by the device 1220 that were unknown at the time of manufacture, but which are known at the time of commissioning. One example of such properties includes deployment location.

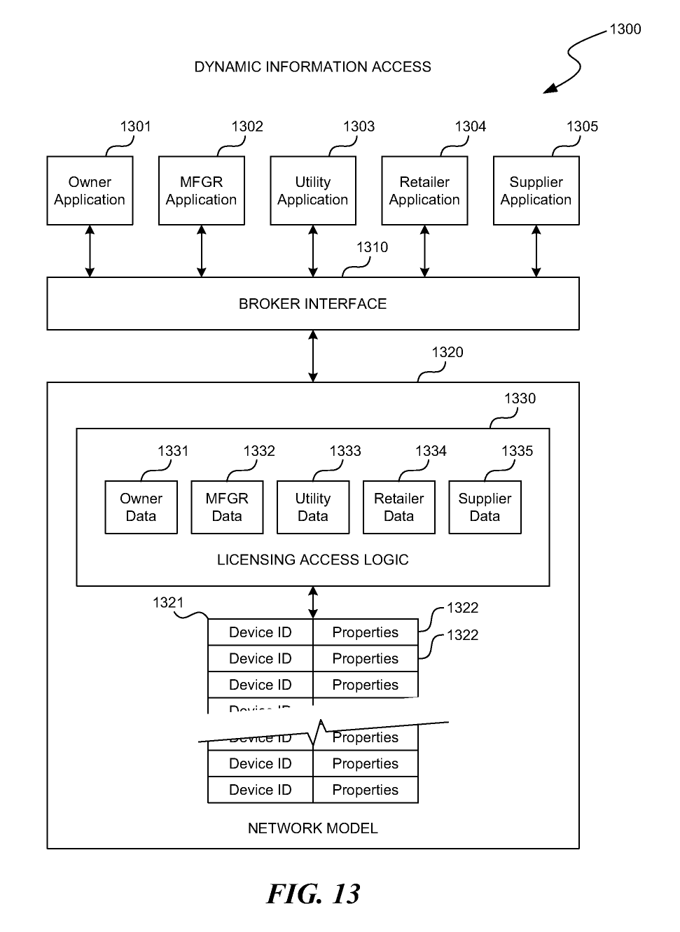

Now turning to FIG. 13, a block diagram is presented featuring a system 1300 according to the present technology for dynamic licensing of information and control features associated with a plurality of wireless devices as described herein. Like the system of FIG. 6, the dynamic licensing system 1300 includes one or more applications 1301-1305 that are allowed restricted access to data and control features corresponding to a plurality of devices (not shown). Although the devices are not depicted, it is noted that they are accessed by a service broker using techniques described above. Also as described above, the various applications 1301-1305 may be distributed and may access the service broker via the Internet, where the broker comprises, for example, an application server coupled to the Internet. In addition, the various components of the service broker may be distributed in various platforms that are functionally and logically coupled to perform the operations noted herein.

The network model 1320 includes device properties logic 1321 that has a plurality of device properties records 1322 as previously described. In addition, the network model 1320 includes licensing access logic 1330. The licensing access logic 1330 has a plurality of licensed data elements 1331-1335 that are each associated with a corresponding application 1301-1305.

In some embodiments, a licensed data element is implemented as an entry in an access control list (ACL) that is attached to a device property identified by a (NetworkID, DeviceID, PropertyID) tuple. In such embodiments, each licensed data element (or ACL entry) identifies the permissions granted to an entity. For example, consider a network in the home of OwnerA that includes a Thermostat device with a CoolingSetpoint property. OwnerA would have the authority to change the CoolingSetpoint by writing this property. OwnerA's utility UtilityA may also have the authority to change the CoolingSetpoint, for example, as part of a Demand Response program in which OwnerA is enrolled. However, another homeowner OwnerB and/or another utility UtilityB would not have the authority to view or change the CoolingSetpoint of OwnerA's Thermostat. If the property was identified in the network model by the tuple (“OwnerANetwork,” “ThermostatDevice,” “CoolingSetpoint”), then the following licensed data elements would appear in an access control list attached to the property: (“OwnerA,” “read/write”), (“UtilityA,” “read/write”), (“OwnerB,” “none”), (“UtilityB,” “none”). As entities (e.g., owners, manufacturers, utilities, etc.) and networks and devices are added to and removed from the system, the licensing access logic dynamically maintains these licensed data elements.

For teaching purposes the types of applications 1301-1305 and data elements 1331-1335 are shown as “owner,” “manufacturer,” “utility,” “retailer,” and “supplier,” because these types of concerns have been previously discussed, but note that any type of application 1301-1305 and corresponding data element 1331-1335 is contemplated under the provision that it is feasible to identify and control a subset of properties records 1322 and a corresponding subset of data therein, such as are described above with reference to FIGS. 8-11.

In operation, the licensing access logic dynamically creates logical subsets 1331-1335 of the properties records 1322 for which access is granted to a corresponding application 1301-1305. For example, as discussed above, a utility with a Demand Response program in which customers may enroll may have the authority to control the CoolingSetpoint properties of Thermostat devices in the homes of enrolled customers. However, the utility would not have the authority to control the CoolingSetpoint properties of Thermostat devices in the homes of customers that are not enrolled in the Demand Response program. Thus, for a logical subset of the CoolingSetpoint properties (i.e., those associated with users enrolled in the Demand Response program), the utility would have “read/write” permissions established by the licensed data elements.

The applications 1301-1305 are therefore restricted from accessing certain records 1322 and properties therein, whether the restriction applies to data or control. As devices are commissioned and decommissioned, the network model 1320 dynamically manipulates contents of the properties records 1322 and licensed data elements 1331-1335 in accordance with specific design configurations, as described above.

### 3. Brokered Processing of Sensor Network Data

The present technology provides apparatus and methods that enable digital signal and other processing functions of sensor data to be offloaded from the end node devices themselves and to be performed remotely through employment of a service broker and/or remote processing server as will be further described hereinbelow. This allows individual device cost to be minimized while at the same time providing tremendous flexibility to reconfigure processing algorithms after a system is deployed. Moreover, the present technology supports processing of samples across a plurality of sensors that are present in one or more sensor networks.

Present day, simple, low cost sensors typically require that digital signal processing (DSP) be applied to data that is provided by the sensors in order to derive useful information therefrom. Digital Signal Processing (DSP) is difficult and expensive, yet today's sensors must provide on-device, “in-situ” DSP to generate useful information.

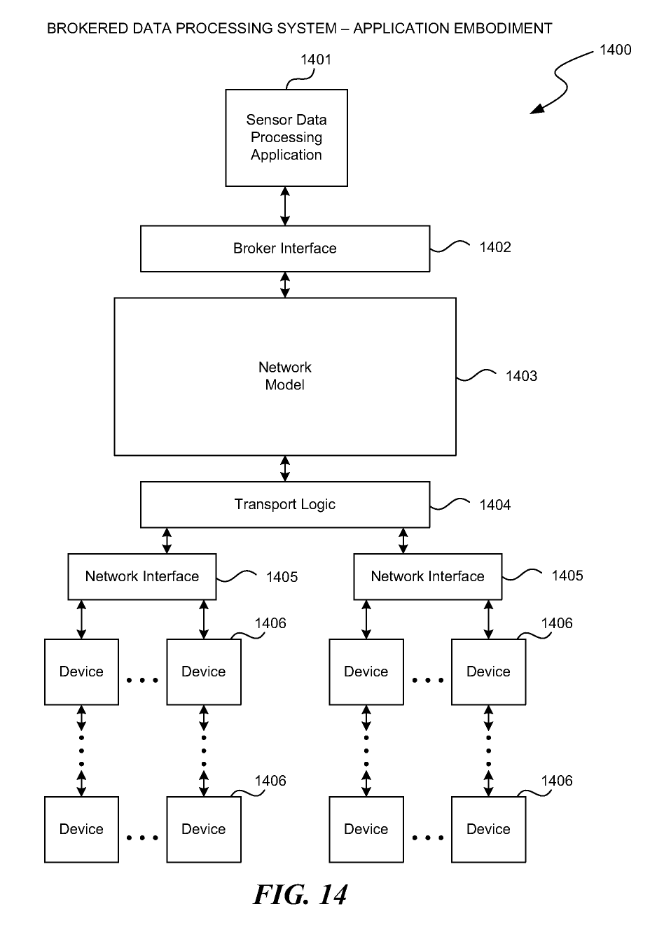

The present technology enables end node devices to offload the processing that currently must be provided for on-device in order to produce useful information. The present technology can be used in any system configuration that employs a network of wireless sensing and control devices, and is particularly applicable to network configurations that include one or end node devices that require additional processing of sensor data in order to obtain useful information. Through employment of a service broker and applications as have herein been described, and as will be further described below with reference to FIGS. 14-16, the processing of data can be performed in a cost-effective, and function-flexible manner, without requiring costly and dedicated on-device circuitry.

Turning now to FIG. 14, a block diagram is presented of embodiments of a brokered data processing system 1400 according to the present technology that features processing of sensor data by an application 1401. Configuration and operation of the elements of the system 1400 of FIG. 14 are substantially similar to like-named elements of the system 600 described above with reference to FIG. 6. A difference between the system 1400 of FIG. 14 and the system 600 of FIG. 6 is that one or more of the applications 1401 of FIG. 14 is configured specifically to perform the processing of data provided by one or more of the devices 1406. In the embodiments shown, the processing application 1401 resides on the same platform as the service broker elements 1402-1405.

As described above, a network model 1403 includes one or more device properties records 800 received from a given device 1406. In some embodiments, a device properties record 800 includes time and data fields, as shown in the run-time profile 1100 of FIG. 11. Accordingly, the application 1401 accesses a device properties record 800 in the network model 1403 as required in accordance with a processing algorithm configured therein to process the data, thus providing useful information. For example, an application may, over time, access the device properties record 800 representing electricity consumption from an electric meter device and combine the consumption data with pricing data obtained from the electric utility to provide the electricity consumer with a profile of their cost of electricity over time.

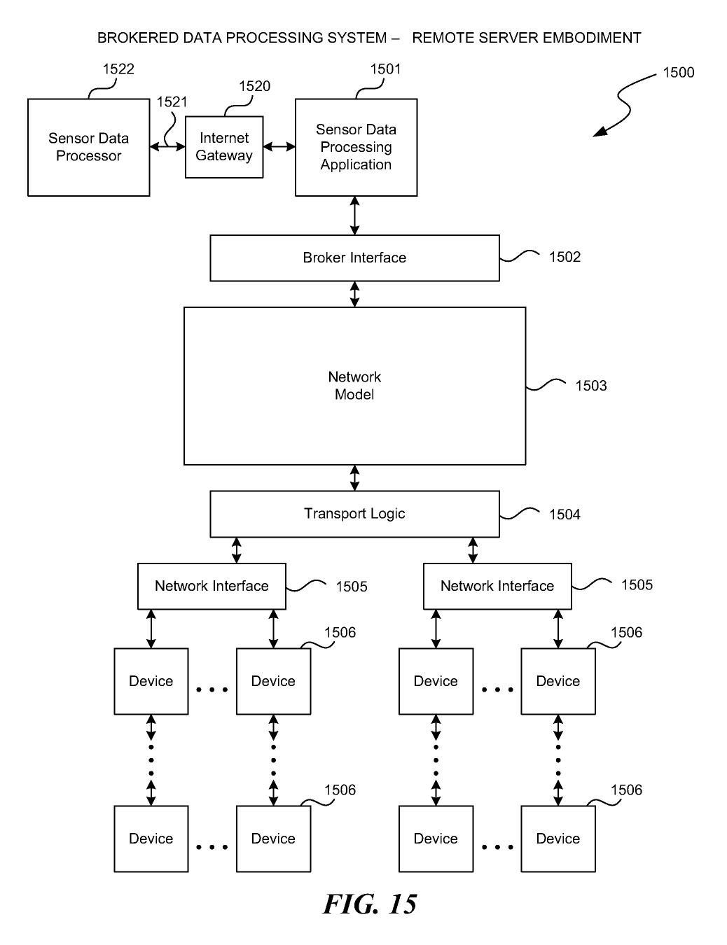

Referring to FIG. 15, a block diagram is presented of other embodiments of a brokered data processing system 1500 according to the present technology. The system 1500 features processing of sensor data by a remote sensor data processor 1522. Configuration and operation of the elements of the system 1500 of FIG. 15 are substantially similar to like-named elements of the system 600. A difference between the system 1500 of FIG. 15 and the system 600 of FIG. 6 is that one or more of the applications 1501 of FIG. 15 is configured specifically to provide for transport of sensor data samples as provided through the broker interface 1502, through an Internet gateway 1520 (or alternative network gateway), so that the samples are routed over the Internet 1521 (or alternative network) to the remote sensor data processor 1522. The remote sensor data processor 1522 then performs the processing of data provided by one or more of the devices 1506. In the embodiment shown, the transport application 1501 resides on the same platform as the service broker elements 1502-1505. Accordingly, the application 1501 accesses the properties record 800 in the network model 1503 as required and provides the required fields to the processor 1522 via the gateway 1520.

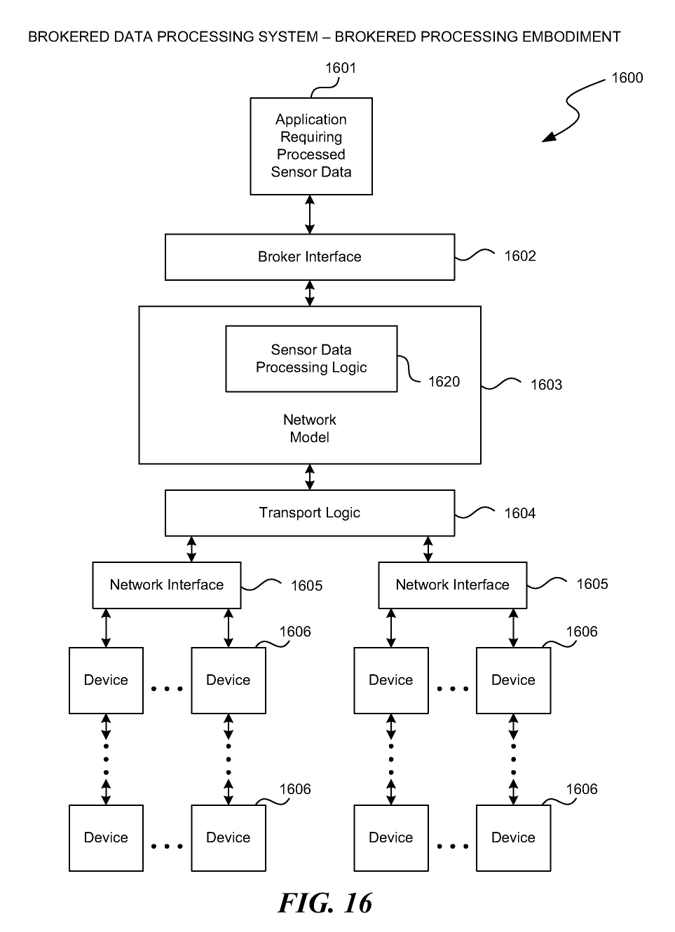

Turning to FIG. 16, a block diagram is presented of further embodiments of a brokered data processing system 1600 according to the present technology. The system 1600 features processing of sensor data by sensor data processing logic 1620 disposed within the network model 1603 itself. Configuration and operation of the elements of the system 1600 of FIG. 16 are substantially similar to like-named elements of the system 600 described above with reference to FIG. 6. A difference between the system 1600 of FIG. 16 and the system 600 of FIG. 6 is that one or more of the applications 1601 of FIG. 16 is configured specifically to receive the useful information that is generated by processing the sensor data. The data processing logic 1620 within the network model performs those processing steps that are necessary to produce meaningful and useful data which is required by the application 1601.

Alternative embodiments contemplate combinations of the embodiments of FIGS. 14-16 where portions of the processing required is performed by the sensor processing logic 1620, the sensor data processor 1522, and the data processing application 1401.

According to the embodiments disclosed herein, more complex processing of sensor data is made possible over that which has heretofore been provided due to the fact that more complex processing elements 1401, 1522, and 1620 are present. Consequently, complex pattern matching algorithms can be executed to the extent which could never be executed by present day circuitry in an end node device. The present technology also supports accessing of data in large data bases, correlation analysis, etc. Furthermore, the embodiments described support algorithms that take into account data from a plurality of sensors, thus providing for calculation of cross-sensor events and estimations. Moreover, the present technology, particularly the embodiment of FIG. 15, enables interested parties to subscribe to sensor data for a period of time, to process the data, and to generate useful information. Exemplary application areas include, but are not limited to, near-real-time water and air systems contamination analysis, support for law enforcement and field/site security operations, HVAC systems analysis and real-time control. Among other benefits, the present technology provides the ability to analyze sensor data that is provided over a period of time.

From the foregoing, it will be appreciated that specific embodiments of the technology have been described herein for purposes of illustration, but that various modifications may be made without deviating from the spirit and scope of the technology. Accordingly, the technology is not limited except as by the appended claims.

I/We claim:

1. A method of dynamically authorizing access to network sensor data, the method comprising:
collecting sensor data in real-time from a plurality of sensing devices configured in a network arrangement, wherein the sensor data includes attributes of the plurality of sensing devices;
dynamically creating subsets of the sensor data, wherein a subset of the sensor data comprises a portion of the sensor data that is authorized for access by an application remote from the plurality of sensing devices; and
providing the application with authorized access to the subset of the sensor data.

2. The method of claim 1 wherein the plurality of sensing devices include a first sensing device and a second sensing device, and further comprising:
communicating with the first sensing device via a first communication protocol; and
communicating with the second sensing device via a second communication protocol, wherein the first communication protocol is different from the first communication protocol.

3. The method of claim 1 wherein the providing the application with authorized access to the subset of the sensor data comprises:
providing the application with authorized access to the subset of the sensor data in real-time.

4. The method of claim 1 wherein the subset of the sensor data comprises data associated with one or more transactions.

5. The method of claim 1 wherein the subset of the sensor data comprises data collected during a given time period.

6. The method of claim 1 wherein the subset of the sensor data comprises data obtained from one or more specified sensing devices.

7. The method of claim 1 wherein the subset of the sensor data is a first subset of the sensor data, and wherein the method further comprises:
providing a second application with access to a second subset of the sensor data, wherein the second subset of the sensor data comprises a portion of the sensor data that is licensed for access by the second application, wherein the second application is remote from the plurality of sensing devices, and wherein the first subset of the sensor data is different than the second subset of the sensor data.

8. A system for providing dynamic access to network sensor information, the system comprising:
a plurality of sensors coupled to a network and configured to provide information to the network; and
a service broker coupled to the network, wherein the service broker is configured to:
obtain the information from the plurality of sensors in real-time;
dynamically create subsets of the information based on whether the information is accessible to entities remote from the plurality of sensors; and
provide authorized access to a subset of the information to an entity remote from the plurality of sensors.

9. The system of claim 8 wherein the network is a wireless mesh network.

10. The system of claim 8 wherein at least one of the sensors is remotely controllable by an entity.

11. The system of claim 8 wherein the subsets of the information include a first subset of the information accessible to a first entity and a second subset of the information accessible to a second entity, wherein the first subset is different than the second subset.

12. The system of claim 8 wherein the service broker provides authorized access to the subset of the information to the entity in real-time.

13. The system of claim 8 wherein the subsets of the sensor data are dynamically recreated as new sensor data is collected.

14. The system of claim 8 wherein the plurality of sensors include:
a first sensor configured to exchange information with the network via a first protocol; and
a second sensor configured to exchange information with the network via a second protocol, wherein the second protocol is different from the first protocol.

15. A data structure for use in providing dynamic access to network device data, the data structure comprising:
device properties logic including a plurality of device properties records, wherein each of the device properties records includes attributes associated a network device; and
access logic including a plurality of access data elements, wherein the access data elements identify permissions of remote entities to access the device properties records.

16. The data structure of claim 15 wherein the device properties records include device design parameters.

17. The data structure of claim 15 wherein the device properties records include device deployment parameters.

18. The data structure of claim 15 wherein the device properties records include device run-time parameters.

19. The data structure of claim 15 wherein at least a portion of the device properties logic is populated by a device manufacturer.

20. The data structure of claim 15 wherein the data structure is stored on a computer-readable medium.
